(19) United States
(12) Patent Application Publication
(10) Pub. No.: US 2013/0100068 A1
(43) Pub. Date: Apr. 25, 2013

(54) TOUCH INPUT SENSING DEVICE AND METHOD THEREOF

(71) Applicants: Yong Il KWON, Suwon (KR); Tah Joon Park, Suwon (KR); Hyun Suk Lee, Suwon (KR)

(72) Inventors: Yong Il KWON, Suwon (KR); Tah Joon Park, Suwon (KR); Hyun Suk Lee, Suwon (KR)

(73) Assignee: SAMSUNG ELECTRO-MECHANICS CO., LTD., Suwon (KR)

(21) Appl. No.: 13/334,389

(22) Filed: Dec. 22, 2011

(30) Foreign Application Priority Data
Oct. 21, 2011 (KR) 10-2011-0108017

(51) Int. Cl. G06F 3/044

(52) U.S. Cl. 345/174

(57) ABSTRACT

There are provided a touch input sensing device and a method thereof. The touch input sensing device includes a panel integrally provided with a display device and including a plurality of sensing electrodes; a sensing circuit unit generating an analog signal from capacitance variations generated in the plurality of sensing electrodes; a signal converting unit generating a digital signal from the analog signal; and a calculating unit judging a touch input from the digital signal, wherein the signal converting unit generates the digital signal by measuring a time required for the analog signal to reach a predetermined reference signal level and controls a time at which the sensing circuit unit generates the analog signal by judging whether the measured time is included in an activation time period of a clock signal of the display device.

### CROSS-REFERENCE TO RELATED APPLICATIONS

This application claims the priority of Korean Patent Application No. 10-2011-0108017 filed on Oct. 21, 2011, in the Korean Intellectual Property Office, the disclosure of which is incorporated herein by reference.

### BACKGROUND OF THE INVENTION

1. Field of the Invention

The present invention relates to a touch input sensing device and a method thereof that can judge a touch input accurately by removing an influence of noise generated from an external apparatus, particularly, a display device.

2. Description of the Related Art

Touch sensing devices such as a touch screen, a touch pad, and the like, as input devices attached to a display apparatus to provide an intuitive input method to a user, have been widely applied to a variety of electronic apparatuses such as a cellular phone, a personal digital assistant (PDA), a vehicle navigation unit, and the like, in recent years. In particular, recently, with an increase in demand for smart phones, the rate at which touch screens have been adopted as touch sensing device elements capable of providing various input methods in a limited form factor has increased on a day by day basis.

Touch screens adopted in portable apparatuses may be largely classified into resistive type and capacitive type touch screens, according to a touch input sensing method. Since the capacitive type touch screen has advantages, in that it may have an extended life-span, and various input methods and gestures can be easily implemented therein, and thus, the adoption rate of the capacitive type touch screen has steadily increased. In particular, it is easier to implement a multi-touch interface in the capacitive type touch screen than in the resistive type touch screen, and as a result, the capacitive type touch screen is widely applied to electronic apparatuses, such as smart phones, and the like.

The touch screen is generally attached to a front surface of the display device and touch input sensing devices other than the touch screen are also generally provided in the electronic apparatus. Accordingly, accuracy in sensing a touch input may be deteriorated due to noise generated from various other electronic components, e.g., a wireless communications unit, the display device and a power supply device, included in the electronic apparatus. An additional shielding layer may be provided between the display device and the touch screen in order to solve the problem, but in this case, overall light transmittance may be deteriorated and product thickness may be increased.

### SUMMARY OF THE INVENTION

An aspect of the present invention provides a touch input sensing device and a method thereof that can judge a touch input accurately by minimizing an influence of noise without an additional shielding layer by controlling a timing of signal detection by the touch input sensing device to be non-synchronous with regard to an interval during which the probability of the occurrence of noise in a display device is high.

According to an aspect of the present invention, there is provided a touch input sensing device, including: a panel integrally provided with a display device and including a plurality of sensing electrodes; a sensing circuit unit generating an analog signal from capacitance variations generated in the plurality of sensing electrodes; a signal converting unit generating a digital signal from the analog signal; and a calculating unit judging a touch input from the digital signal, wherein the signal converting unit generates the digital signal by measuring a time required for the analog signal to reach a predetermined reference signal level and controls a time at which the sensing circuit unit generates the analog signal by judging whether the measured time is included in an activation time period of a clock signal of the display device.

The signal converting unit may delay, by a predetermined interval, the time at which the sensing circuit unit generates the analog signal when the measured time is included in the activation time period of the clock signal.

The sensing circuit unit may generate a voltage signal from the capacitance variations.

The sensing circuit unit may include an integral circuit generating the voltage signal from the capacitance variations.

The signal converting unit may generate the digital signal by measuring a time required for the voltage signal to reach a predetermined reference voltage level.

The signal converting unit may delay, by a predetermined interval, a time at which the integral circuit starts integrating the capacitance variations when the measured time is included in the activation time period of the clock signal.

The signal converting unit may generate the digital signal from the measured time when the measured time is included in an inactivation time period of the clock signal.

The sensing circuit unit may generate the analog signal from mutual-capacitance variations generated among the plurality of sensing electrodes.

The sensing circuit unit, the signal converting unit, and the calculating unit may be configured as an integrated circuit (IC).

According to another aspect of the present invention, there is provided a touch input sensing method, including: acquiring information on a clock signal of a display device; generating an analog signal from capacitance variations generated from a plurality of sensing electrodes; generating a digital signal by measuring a time required for the analog signal to reach a predetermined reference signal level; and controlling a time of generating the analog signal by judging whether the measured time is included in an activation time period of the clock signal.

In the controlling of the time, the time of generating the analog signal may be shifted by a predetermined interval when the measured time is included in the activation time period of the clock signal.

A touch input may be judged based on the digital signal.

In the generating of the analog signal, a voltage signal may be generated by integrating the capacitance variations.

In the controlling of the time, a start time of integrating the capacitance variations may be shifted by a predetermined interval when the measured time is included in the activation time period of the clock signal.

In the generating of the analog signal, the analog signal may be generated from mutual-capacitance variations generated among the plurality of sensing electrodes.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view showing an exterior of an electronic apparatus including a touch input sensing device according to an embodiment of the present invention;

FIG. 2 is a plan view showing a touch sensing panel electrically connected with a touch input sensing device according to an embodiment of the present invention;

FIG. 3 is a cross-sectional view of the touch sensing panel shown in FIG. 2;

FIG. 4 is a block diagram of a touch input sensing device according to an embodiment of the present invention;

FIG. 5 is a graph illustrating an operation of a touch input sensing device according to an embodiment of the present invention;

FIG. 6 is a timing diagram illustrating an operation of a touch input sensing device according to an embodiment of the present invention; and

FIG. 7 is a flowchart illustrating a method of sensing a touch input according to an embodiment of the present invention.

### DETAILED DESCRIPTION OF THE INVENTION

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

Embodiments described in the specification and structures illustrated in drawings are merely exemplary embodiments of the present invention. Thus, it is intended that the present invention covers the modifications and variations of this invention, provided they fall within the scope of their equivalents at the time of filing this application

Like reference numerals designate like components having substantially the same constitution and function in the drawings of the present invention.

Hereinafter, embodiments of the present invention will be described in detail with reference to the accompanying drawings so that those skilled in the art may easily practice the present invention.

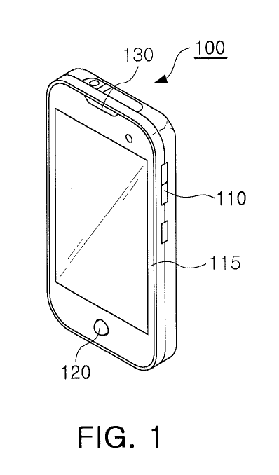

FIG. 1 is a view showing an exterior of an electronic apparatus including a touch input sensing device according to an embodiment of the present invention. Referring to FIG. 1, an electronic apparatus 100 according to an embodiment of the present invention includes a display device 110 for outputting an image, an input unit 120, and an audio unit 130 for outputting voice, and may include a touch input sensing device which is integrated with the display device 110.

As shown in FIG. 1, in the case of a mobile apparatus, the touch input sensing device is generally provided integrally with the display device, and the touch input sensing device should have a high level of light transmittance for the image displayed by the display device to penetrate the touch input sensing device. Therefore, the touch input sensing device may be realized by forming a sensing electrode made of a material which is transparent and has electrical conductivity, such as indium-tin oxide (ITO), indium zinc oxide (IZO), zinc oxide (ZnO), carbon nano tube (CNT), or graphene, on a base substrate made of a transparent film material such as polyethylene terephthalate (PET), polycarbonate (PC), polyethersulfone (PES), polyimide (PI), or the like. A wiring pattern connected with the sensing electrode made of the transparent conductive material is placed in a bezel area 115 of the display device. Since the wiring pattern is visually shielded by the bezel area 115, the wiring pattern may be made of even a metallic material such as silver (Ag) or copper (Cu).

In a case in which the touch input sensing device according to the embodiment of the present invention may not be provided integrally with the display device, such as in the case of a notebook computer touch pad, the touch input sensing device may be manufactured by simply patterning the sensing electrode on a circuit board with metal. However, for convenience of explanation, a touch input sensing device and a method thereof according to embodiments of the present invention will be described on the assumption of a touch screen.

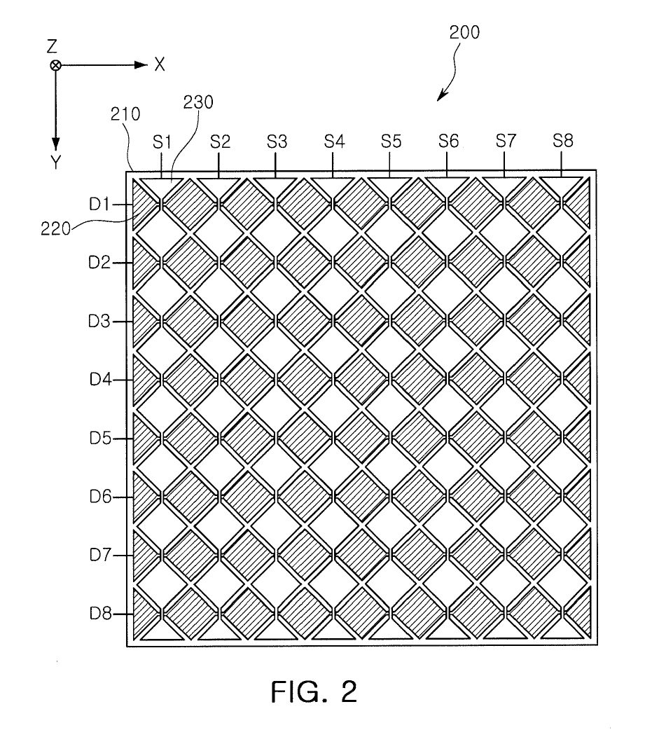

FIG. 2 is a plan view showing a touch sensing panel electrically connected with a touch input sensing device according to an embodiment of the present invention.

Referring to FIG. 2, a touch sensing panel 200 according to this embodiment includes a substrate 210 and a plurality of sensing electrodes 220 and 230 provided on the substrate 210. Although not shown in FIG. 2, each of the plurality of sensing electrodes 220 and 230 may be electrically connected with the wiring pattern of the circuit board attached to one end of the substrate 210 through a wire and a bonding pad. A controller integrated circuit is mounted on the circuit board to detect signals generated from the plurality of sensing electrodes 220 and 230 and judge the touch input based thereon.

In the touch screen device, the substrate 210 may be a transparent substrate in which the sensing electrodes 220 and 230 can be formed and may be formed of a plastic material such as polyimide (PI), polymethylmethacrylate (PMMA), polyethyleneterephthalate (PET), or polycarbonate (PC) or tempered glass. Further, apart from an area in which the sensing electrodes 220 and 230 are formed, a predetermined printing area for the wire connected with the sensing electrodes 220 and 230 may be formed on the substrate 210 in order to visually shield the wire formed of an opaque metallic material.

The plurality of sensing electrodes 220 and 230 may be provided on one surface or both surfaces of the substrate 210. In the case of the touch screen device, the plurality of sensing electrodes 220 and 230 may be formed of a transparent conductive material such as indium-tin oxide (ITO), indium zinc-oxide (IZO), zinc oxide (ZnO), carbon nano tube (CNT), or a graphene based material. Although the sensing electrodes 220 and 230 have a rhombus, or diamond-shaped, pattern as shown in FIG. 2, the sensing electrodes 220 and 230 may have various patterns using polygonal shapes such as a rectangle, a triangle, and the like.

The plurality of sensing electrodes 220 and 230 include first electrodes 220 extending in an X-axis direction and second electrodes 230 extending in a Y-axis direction. The first and second electrodes 220 and 230 may be provided on both surfaces of the substrate 210 or provided on different substrates to intersect each other. In the case in which both the first and second electrodes 220 and 230 are provided on one surface of the substrate 210, a predetermined insulating layer may be partially formed at an intersecting point between the first and second electrodes 220 and 230.

A touch input sensing device that is electrically connected with the plurality of sensing electrodes 220 and 230 to sense a touch input detects capacitance variations sensed in the plurality of sensing electrodes 220 and 230 and senses the touch input therefrom. The first electrodes 220 are connected to channels defined as D1 to D8 in the controller integrated circuit to receive predetermined driving signals, and the second electrodes 230 are connected to channels defined as S1 to S8 to be used in order for the controller integrated circuit to detect sensed signals. In this case, the controller integrated circuit may detect mutual-capacitance variations generated between the first and second electrodes 220 and 230 as the sensed signals, and may sequentially apply the driving signals to the individual first electrodes 220 and simultaneously detect capacitance variations from the second electrodes 230.

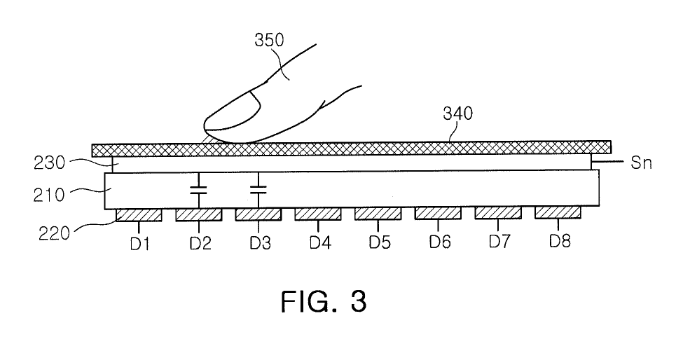

FIG. 3 is a cross-sectional view of the touch sensing panel shown in FIG. 2.

FIG. 3 is a cross-sectional view of the touch sensing panel 200 shown in FIG. 2 taken in a Y-Z direction. The touch sensing panel 200 may further include a cover lens 340 receiving the touch input, in addition to the substrate 210 and the plurality of sensing electrodes 220 and 230 described in FIG. 2. The cover lens 340 is provided on the second electrodes 230 used to detect the sensed signals such that it may receive the touch input from a touching object 350 such as a finger.

When the driving signals are sequentially applied to the first electrodes 220 through the channels D1 to D8, mutual-capacitance is generated between the first and second electrodes 220 and 230. When the driving signals are sequentially applied to the first electrodes 220, a capacitance variation may occur between the first and second electrodes 220 and 230 adjacent to an area contacted by the touching object 350. The capacitance variation may be proportionate to a dimension of an area overlapped among the touching object 350, the first electrodes 220 applied with the driving signals and the second electrodes 230. In FIG. 3, the mutual-capacitance generated between the first and second electrodes 220 and 230 connected to the channels D2 and D3 is influenced by the touching object 350.

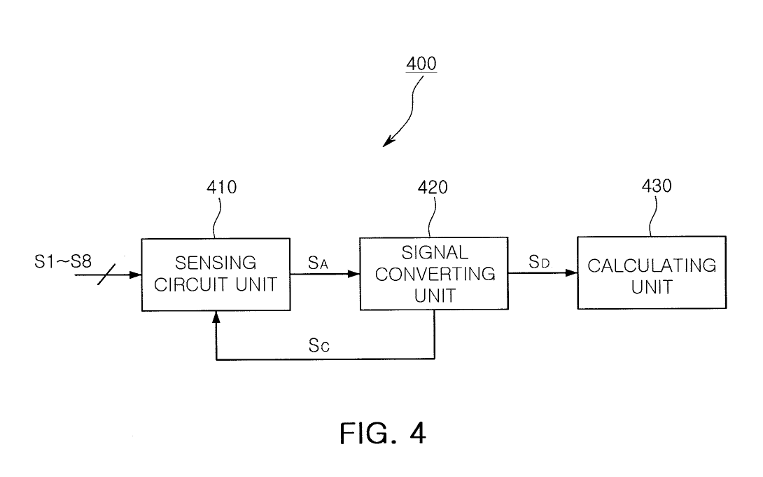

FIG. 4 is a block diagram of a touch input sensing device according to an embodiment of the present invention.

Referring to FIG. 4, a touch input sensing device 400 according to an embodiment of the present invention includes a sensing circuit unit 410, a signal converting unit 420, and a calculating unit 430. The sensing circuit unit 410 connected with the plurality of second electrodes 230 generates an analog signal S_{A} by sensing capacitance variations through the channels S1 to S8 and transfers the generated analog signal to the signal converting unit 420. The signal converting unit 420 converts the analog signal S_{A} into the digital signal S_{D} and transfers the digital signal S_{D} to the calculating unit 430. The calculating unit 430 may judge a position of the touch input, a gesture, a time at which the touch input is applied, and the like from the digital signal S_{D}. Meanwhile, the sensing circuit unit 410, the signal converting unit 420, and the calculating unit 430 shown in FIG. 4 may be configured as an integrated circuit (IC).

The sensing circuit unit 410 may include an integral circuit for converting the capacitance variations generated in the plurality of individual second electrodes 230, into the voltage type analog signal S_{A}. Therefore, a total of eight integral circuits may be included in the sensing circuit unit 410 in order to sense the capacitance variations from the plurality of second electrodes 230 connected to the eight channels S1 to S8, respectively. Further, an operation of the sensing circuit unit 410 may be controlled by a control signal S_{c} transferred from the signal converting unit 420.

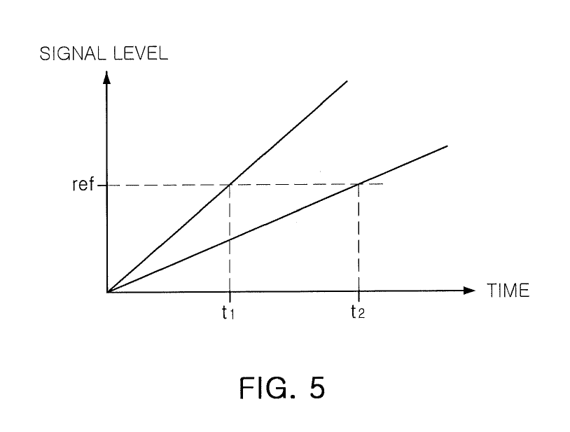

The signal converting unit 420 generates the digital signal S_{D} from the analog signal S_{A}. As an example, the signal converting unit 120 may be a time-to-digital converter (TDC) circuit measuring a time required for the voltage type analog signal S_{A} transferred from the sensing circuit unit 410 to reach a predetermined reference voltage level and converting the measured time into the digital signal S_{D}. Hereinafter, the operation of the touch input sensing device according to the embodiment of the present invention will be described with reference to FIG. 5.

FIG. 5 is a graph illustrating the operation of the touch input sensing device according to the embodiment of the present invention.

Referring to FIG. 5, a time required to reach a reference signal level ref is measured as t1 with respect to V1 and t2 with respect to V2. That is, both cases are different from each other in terms of the time required to reach the reference signal level ref according to the voltage signal measured by the sensing circuit unit 410. The signal converting unit 420 measures the times t1 and t2 and converts the times t1 and t2 into the digital signal in a delay cell circuit constituted of a buffer and a latch.

The capacitance variations generated among the plurality of sensing electrodes 220 and 230 are proportionate to dimensions of areas overlapped among the touching object and the plurality of sensing electrodes 220 and 230. Therefore, when the dimensions of the areas overlapped among the sensing electrodes 220 and 230 and the area contacted by the touching object are large, the capacitance variations are relatively large, and as a result, the voltage signal may vary relatively slowly. That is, when a time at which the voltage increases in the signal converting unit 420 configured as the TDC circuit is measured, the case in which the capacitance variations are larger corresponds to V2 of FIG. 5 and the case in which the capacitance variations are smaller corresponds to V1 of FIG. 5.

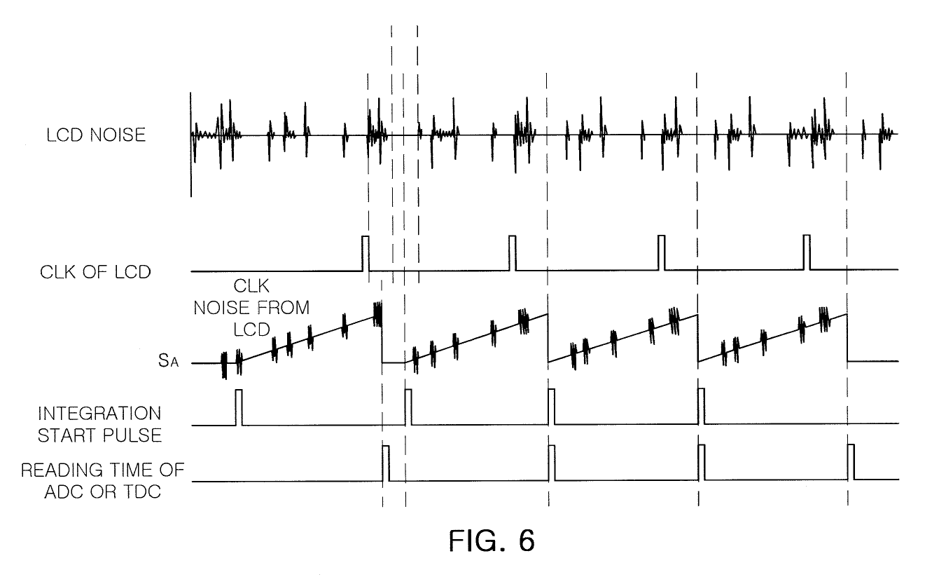

Since the signal converting unit 420 configured as the TDC circuit measures the time t1 or t2 when the voltage signal V1 or V2 reaches the reference level ref, the signal converting unit 420 may not measure an accurate time when noise is generated in the display device at the time t1 or t2 measured by the signal converting unit 420. Accordingly, to this end, when noise is generated at the times t1 and t2 measured by the signal converting unit 420, the influence of noise is minimized by delaying the time at which the sensing circuit unit 410 operates the integral circuit, in order to measure the capacitance variations, by a predetermined interval. Hereinafter, the operation of the touch input sensing device according to the embodiment will be described with reference to a timing diagram of FIG. 6.

FIG. 6 is a timing diagram illustrating an operation of a touch input sensing device according to an embodiment of the present invention.

Referring to FIG. 6, it is assumed that the display device is a liquid crystal display (LCD) and the graphs of FIG. 6 show a period during which noise is generated in the LCD device and a timing of a clock signal for driving the LCD device, and the voltage signal measured as the analog signal S_{A}. Referring to the LCD noise shown in FIG. 6 and the clock signal timing diagram for driving the LCD device, a relatively large amount of noise is generated from the LCD when the clock signal for driving the LCD device is activated.

In FIG. 6, the voltage signal measured as the analog signal S_{A} is shown as a four-part cycle. Referring to a first cycle, the voltage signal S_{A} is generated by charging or discharging the capacitance variations generated from the sensing electrodes 220 and 230 through an integration start pulse, and the signal converting unit 420 reads a time at which the voltage signal S_{A} reaches the predetermined reference voltage ref to generate the digital signal S_{D}. However, since a large amount of noise is generated from the LCD device at the time at which the signal converting unit 420 reads the voltage signal S_{A} in the first cycle of FIG. 6, the time measured by the signal converting unit 420 may be erroneous.

Therefore, when it is judged that the time at which the signal converting unit 420 reads the voltage signal S_{A} in a predetermined cycle is non-synchronous with, or included in the interval in which the large amount of noise is generated from the LCD device, that is, the period of activation of the clock signal for driving the LCD device, or included in a predetermined range from the period, the time of operating the integral circuit of the sensing circuit unit 410 is shifted in order to generate the voltage signal S_{A} in the next cycle. Referring to FIG. 6, it can be verified that the time at which the integration start pulse is applied in a second cycle is delayed by a predetermined interval, and accordingly, the time at which the signal converting unit 420 reads the voltage signal S_{A} is controlled to be non-synchronous with the time at which the large amount of noise is generated from the LCD device.

That is, as shown in FIG. 4, the time at which the sensing circuit unit 410 operates the integral circuit may be determined by the control signal S_{c} controlled depending on whether LCD noise is generated at the time at which the signal converting unit 420 reads the voltage signal S_{A}. Whet it is judged that LCD noise is not generated at the time at which the signal converting unit 420 reads the voltage signal S_{A}, the signal converting unit 420 generates the digital signal by reading the voltage signal S_{A} from the next sensing electrode as it is, without delaying the time at which the integral circuit of the sensing circuit unit 410 operates.

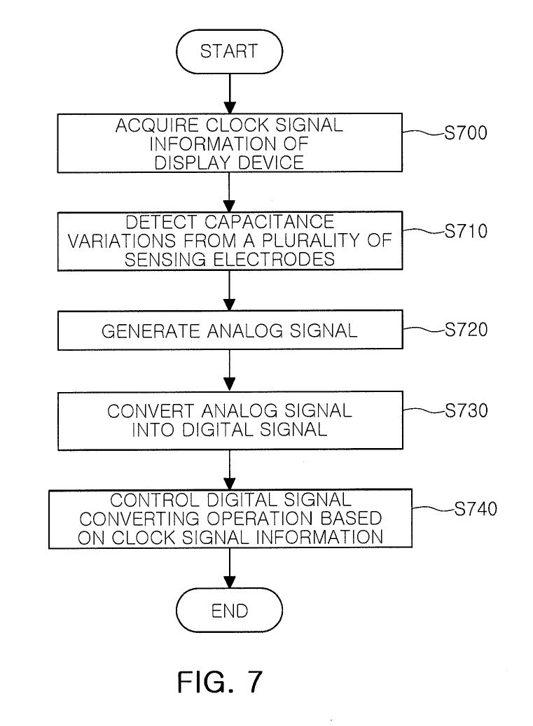

FIG. 7 is a flowchart illustrating a method of sensing a touch input according to an embodiment of the present invention.

Referring to FIG. 7, a touch input sensing method according to an embodiment of the present invention starts when information on a clock signal of the display device is acquired (S700). The display device may include a gate driver circuit and a data driver circuit for driving a plurality of switching elements arranged in a matrix. The touch input sensing device may acquire the clock signal information such as a cycle of the operating clock signal of the gate driver circuit or the data driver circuit and a time period of activation of the clock signal.

The sensing circuit unit 410 detects capacitance variations from the plurality of sensing electrodes 220 and 230 (S710). The sensing circuit unit 410 may apply a predetermined driving signal to the first electrode 220 among the plurality of sensing electrodes 220 and 230 and detect a mutual-capacitance variation from the second electrode 230 intersecting the first electrode to which the driving signal is applied. The sensing circuit unit 410 may include integral circuits for detecting the mutual-capacitance variation as a voltage signal. That is, the sensing circuit unit 410 generates an analog signal S_{A} from the capacitance variations generated from the plurality of sensing electrodes 220 and 230 (S720).

The analog signal S_{A} generated by the sensing circuit unit 410 is transferred to the signal converting unit 420 to be converted into a digital signal S_{D} (S730). The digital signal S_{D} is transferred to the calculating unit 430 to be used for judging a touch input.

Meanwhile, in the present embodiment, the digital signal converting operation is controlled based on the clock signal information acquired in operation S700 (S740). That is, when it is judged that an influence of noise generated from the display device is included in the converted digital signal S_{D} during the digital signal converting operation in operation S730, a start time of an integrating operation for detecting the capacitance variations in operation S710 is delayed by a predetermined interval to minimize the influence of noise of the display device from the next cycle. Whether the digital signal S_{D} is influenced by noise may be determined based on whether the time at which the digital signal S_{D} is measured is included in the timing of the activation of the clock signal included in the clock signal information acquired in operation S700.

In describing various embodiments of the present invention up to now, it is assumed that the signal converting unit 420 is configured as the TDC circuit. However, the signal converting unit 420 may be configured as an analog-to-digital converter (ADC) circuit. Unlike the TDC circuit, the ADC circuit uses a method of detecting capacitance variations by measuring a voltage signal level varying for a predetermined reference time. Accordingly, in order to measure the variations of the voltage signal level, when it is judged that the predetermined reference time is included in the period of the activation of the clock signal to be influenced by the noise of the display device, the integration start time is delayed to thereby minimize the influence of noise.

As set forth above, in a touch input sensing device and a method thereof according to embodiments of the present invention, a time at which a signal converting unit detects an analog signal and converts the detected analog signal into a digital signal is controlled according to a timing of activation of a clock signal of a display device. Accordingly, a touch input can be accurately judged by minimizing an influence of noise generated in the display device without an additional shielding layer.

While the present invention has been shown and described in connection with the exemplary embodiments, it will be apparent to those skilled in the art that modifications and variations can be made without departing from the spirit and scope of the invention as defined by the appended claims.

What is claimed is:

1. A touch input sensing device, comprising:
a panel integrally provided with a display device and including a plurality of sensing electrodes;
a sensing circuit unit generating an analog signal from capacitance variations generated in the plurality of sensing electrodes;
a signal converting unit generating a digital signal from the analog signal; and
a calculating unit judging a touch input from the digital signal,
wherein the signal converting unit generates the digital signal by measuring a time required for the analog signal to reach a predetermined reference signal level and controls a time at which the sensing circuit unit generates the analog signal by judging whether the measured time is included in an activation time period of a clock signal of the display device.

2. The touch input sensing device of claim 1, wherein the signal converting unit delays, by a predetermined interval, the time at which the sensing circuit unit generates the analog signal when the measured time is included in the activation time period of the clock signal.

3. The touch input sensing device of claim 1, wherein the sensing circuit unit generates a voltage signal from the capacitance variations.

4. The touch input sensing device of claim 3, wherein the sensing circuit unit includes an integral circuit generating the voltage signal from the capacitance variations.

5. The touch input sensing device of claim 3, wherein the signal converting unit generates the digital signal by measuring a time required for the voltage signal to reach a predetermined reference voltage level.

6. The touch input sensing device of claim 4, wherein the signal converting unit delays, by a predetermined interval, a time at which the integral circuit starts integrating the capacitance variations when the measured time is included in the activation time period of the clock signal.

7. The touch input sensing device of claim 1, wherein the signal converting unit generates the digital signal from the measured time when the measured time is included in an inactivation time period of the clock signal.

8. The touch input sensing device of claim 1, wherein the sensing circuit unit generates the analog signal from mutual-capacitance variations generated among the plurality of sensing electrodes.

9. The touch input sensing device of claim 1, wherein the sensing circuit unit, the signal converting unit, and the calculating unit are configured as an integrated circuit (IC).

10. A touch input sensing method, comprising:
acquiring information on a clock signal of a display device;
generating an analog signal from capacitance variations generated from a plurality of sensing electrodes;
generating a digital signal by measuring a time required for the analog signal to reach a predetermined reference signal level; and
controlling a time of generating the analog signal by judging whether the measured time is included in an activation time period of the clock signal.

11. The touch input sensing method of claim 10, wherein, in the controlling of the time, the time of generating the analog signal is shifted by a predetermined interval when the measured time is included in the activation time period of the clock signal.

12. The touch input sensing method of claim 10, wherein a touch input is judged based on the digital signal.

13. The touch input sensing method of claim 10, wherein, in the generating of the analog signal, a voltage signal is generated by integrating the capacitance variations.

14. The touch input sensing method of claim 13, wherein, in the controlling of the time, a start time of integrating the capacitance variations is shifted by a predetermined interval when the measured time is included in the activation time period of the clock signal.

15. The touch input sensing method of claim 10, wherein, in the generating of the analog signal, the analog signal is generated from mutual-capacitance variations generated among the plurality of sensing electrodes.
